(19) United States
(12) Patent Application Publication
(10) Pub. No.: US 2014/0248399 A1
(43) Pub. Date: Sep. 4, 2014

(54) BOURBON SOAKED PRETZEL PRODUCTS AND METHODS FOR MAKING THE SAME

(71) Applicant: Carolyn Downey Talucci, Baltimore, MD (US)

(72) Inventor: Carolyn Downey Talucci, Baltimore, MD (US)

(21) Appl. No.: 14/193,718

(22) Filed: Feb. 28, 2014

Related U.S. Application Data
(60) Provisional application No. 61/770,877, filed on Feb. 28, 2013.

(51) Int. Cl. A21D 13/00; A21D 8/00

(52) U.S. Cl. CPC A21D 13/0061; A21D 8/00
USPC 426/94; 426/307; 426/303

(57) ABSTRACT

The present invention provides for bourbon soaked pretzel products and methods for making the same. In certain embodiments of the present invention, the pretzels are dipped in a bourbon-butter mixture and then baked. In certain embodiments of the present invention, the pretzels are dipped a second time in a bourbon-butter mixture and then baked.

### TECHNICAL FIELD

The present invention relates generally to bourbon soaked pretzel products and methods for making the same.

### BACKGROUND

Pretzels are a common snack food, enjoyed by individuals for hundreds of years. Pretzels are available both in hard and soft varieties. More recently, pretzels have been made with a variety of flavors. During the dough making process, the pretzels can be flavored. Alternatively, after initial baking, the pretzels can be dipped or coated with a variety of ingredients.

Pretzels can be coated with a variety of flavors. These flavors can be applied to the pretzels and then baked into the pretzels. The coatings applied to pretzels can be of differing viscosities. Certain coatings can be too viscous or runny, or have inconsistent flavor. Moreover, the processes used to apply various coatings can have a negative impact on flavor and/or the consistency of the coating and final pretzel product. Thus, there is a need to create a coating with the optimal consistency and flavor characteristics, as well as a method for making a flavored pretzel product using the coating, that maximizes the flavor and consistency of the coating and final food product.

### SUMMARY

The present invention provides for bourbon soaked pretzel products and methods for making the same. In certain embodiments of the present invention, the pretzels are dipped in a bourbon-butter mixture and then baked. In certain embodiments of the present invention, the pretzels are dipped a second time in a bourbon-butter mixture and then baked.

In one particular embodiment, a method for making a bourbon soaked pretzel is provided. The method includes providing an uncoated pretzel. The method includes melting an amount of a butter and an amount of a brown sugar to produce a butter mixture. The method further includes providing an amount of bourbon, adding an amount of garlic powder and an amount of cayenne to the bourbon and whisking the garlic powder and cayenne into the bourbon to produce a bourbon mixture. The method further includes adding the bourbon mixture to the butter mixture, whisking the butter mixture and the bourbon mixture together for a period of time to create a butter-bourbon mixture and pouring the butter-bourbon mixture onto the at least one uncoated pretzel. Next, the method provides for tossing the at least one pretzel in the butter-bourbon mixture until an amount of butter-bourbon mixture is remaining to produce at least one coated pretzel and baking the at least one coated pretzel for a period of time. The method further includes placing the at least one coated pretzel in a room temperature environment for a period of time. The method also includes baking the at least one coated pretzel for a period of time.

In one particular embodiment, the method described in the preceding paragraph further includes a second dipping process. The method for the second dipping process includes providing the at least one coated pretzel. The method further provides for melting an amount of a butter and an amount of a brown sugar to produce a butter mixture. The method also includes providing an amount of bourbon, adding an amount of garlic powder and an amount of cayenne to the bourbon and whisking the garlic powder and cayenne into the bourbon to produce a bourbon mixture. The method further provides adding the bourbon mixture to the butter mixture, whisking the butter mixture and the bourbon mixture together for a period of time to create a butter-bourbon mixture and pouring the butter-bourbon mixture onto the at least one uncoated pretzel. Next, the method includes tossing the at least one pretzel in the butter-bourbon mixture until an amount of butter-bourbon mixture is remaining to produce at least one coated pretzel and baking the at least one coated pretzel for a period of time. The method further includes placing the at least one coated pretzel in a room temperature environment for a period of time. The method also includes baking the at least one coated pretzel for a period of time.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 illustrates a flow diagram of an exemplary first dipping process in accordance with exemplary embodiments of the present invention.

FIG. 2 illustrates a flow diagram of an exemplary second dipping process in accordance with exemplary embodiments of the present invention.

### DETAILED DESCRIPTION

Embodiments of the present invention include a method for making a bourbon soaked pretzel. In certain embodiments of the present invention, the process involves a first dipping process. In certain embodiments of the present invention, the process involves a first dipping process immediately followed by a second dipping process.

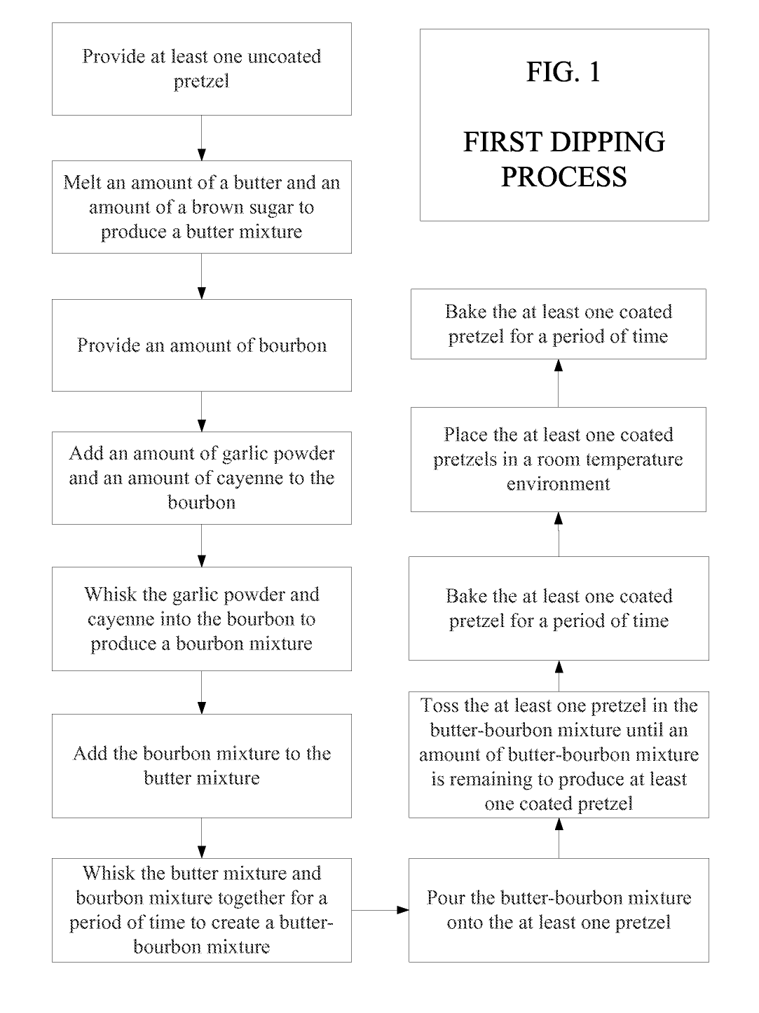

Referring now to FIG. 1, a flow diagram illustrating the steps of a method for a first dipping process in accordance with exemplary embodiments of the present invention is provided. In an embodiment of the present invention, method 100 includes providing an uncoated pretzel (step 101). The uncoated pretzel can be a hard variety pretzel or a soft variety pretzel. The hard or soft pretzel can be prepared by any known recipe for making a pretzel. Alternatively, the uncoated pretzel can be any of a variety of brand pretzel products, including Snyder's® or Utz® pretzels. In an embodiment of the invention, one barrel of Utz® hard pretzels is used. In an embodiment of the invention, the pretzels are broken into bite size pieces and placed in a large bowl. After breaking the pretzels into bite size pieces, the remaining salt and/or pretzel crumbs can be discarded from the bowl.

Next, in method 100, an amount of a butter and an amount of a brown sugar are melted to produce a butter mixture (step 102). The butter can be salted or unsalted butter. The butter and brown sugar can be any type, as would be understood by a person of ordinary skill in the art. In an embodiment of the invention, the amount of butter is one pound of salted butter. In an embodiment of the invention, the amount of brown sugar is ½ cup of brown sugar. As would be understood by a person of ordinary skill in the art, the butter and brown sugar can be melted in a thick bottom pot. Further, a whisk can be used to dissolve the brown sugar clumps.

Further, in method 100, an amount of bourbon is provided (step 103). As would be understood by a person of ordinary skill in the art, any type of bourbon can be used. In an embodiment of the invention, the amount of bourbon is ¾ cup of bourbon. In an embodiment of the invention, the bourbon is provided in a liquid measuring cup.

Next, in method 100, an amount of garlic powder and an amount of cayenne are added to the bourbon (step 104). In an embodiment of the invention, the amount of garlic powder is three teaspoons of garlic powder. In an embodiment of the invention, the amount of cayenne is one teaspoon. The garlic powder and cayenne can be added to the liquid measuring cup containing the bourbon.

Next, in method 100, the garlic powder and cayenne is whisked into the bourbon to produce a bourbon mixture (step 105). In an embodiment of the invention, the garlic powder and cayenne is whisked immediately after adding the ingredients to the bourbon. The garlic powder and cayenne can be whisked until the powders are dissolved and no clumps are observed, as would be understood by a person of ordinary skill in the art.

Next, in method 100, the bourbon mixture is added to the butter mixture (step 106). In an embodiment of the invention, the bourbon mixture is added to the butter mixture in a thick bottom pot. The pot may make a hissing noise once the bourbon mixture is added to the butter mixture.

Next, in method 100, the butter mixture and the bourbon mixture are whisked together for a period of time to create a butter-bourbon mixture (step 107). In an embodiment of the invention, the butter mixture and the bourbon mixture are whisked together for a minute. As would be understood by a person of ordinary skill in the art, the butter mixture and the bourbon mixture can be whisked until it is a golden brown.

Further, in method 100, the butter-bourbon mixture is poured onto the at least one uncoated pretzel (step 108). In an embodiment of the invention, the butter-bourbon mixture is poured evenly onto the pretzels.

Next, in method 100, the at least one pretzel is tossed in the butter-bourbon mixture until an amount of butter-bourbon mixture is remaining to produce at least one coated pretzel (step 109). In an embodiment of the invention, a large spatula is used to toss the pretzels in a butter-bourbon mixture. The butter-bourbon mixture can be tossed until there is no amount of butter-bourbon mixture remaining. Alternatively, the butter-bourbon mixture can be tossed until a portion of the butter-bourbon mixture is remaining. In an embodiment of the present invention, the pretzels are tossed for a few minutes in the butter-bourbon mixture. A clear bowl can be used for tossing the pretzels so that the contents of the bowl can easily be viewed to determine the amount of liquid butter-bourbon mixture is remaining.

Further, in method 100, the at least one coated pretzel is baked for a period of time (step 110). In an embodiment of the invention, the oven is pre-heated prior to heating the at least one coated pretzel. The pretzels can be placed on baking sheets with parchment paper prior to inserting into the oven. The pretzels may be touching each other on the baking sheet. The pretzels, however, should not be piled high as to prevent the pretzels from baking thoroughly. As would be understood by one of ordinary skill in the art, a convection oven can be used. An exemplary convection oven for use with the present invention is an Energy Star Blodgett convection oven. Alternatively, a standard, household oven can be used. Exemplary personal ovens include the Samsung 30 inch oven, model number NX583G0VBSR or the LG 30 inch oven, model number LDG3016ST. In an embodiment of the invention, the baking sheets containing the pretzels are placed on the center rack of the oven and away from the bottom of the oven to avoid burning. In an embodiment of the invention, the pretzels are baked in a household oven for 20 minutes at 250 degrees Farenheit. In an embodiment of the invention, the pretzels are baked in a convection oven for 15 minutes at 250 degrees Farenheit. As would be understood by one of ordinary skill in the art, the time for baking may alter depending on the oven being used.

Next, in method 100, the at least one coated pretzel is placed in a room temperature environment for a period of time (step 111). While in a room temperature environment, the pretzels can be mixed on the baking sheet.

Next, in method 100, the at least one coated pretzel is baked for a second period of time (step 112). In an embodiment of the invention, the pretzels are baked for a second period of time in a standard, household oven for 20 minutes at 250 degrees Fahrenheit. In an embodiment of the invention, the pretzels are baked for a second period of time in a convection oven for 10 minutes at 250 degrees Fahrenheit. Once the at least one coated pretzel is baked, it can be removed from the oven and placed at room temperature for 10-15 minutes.

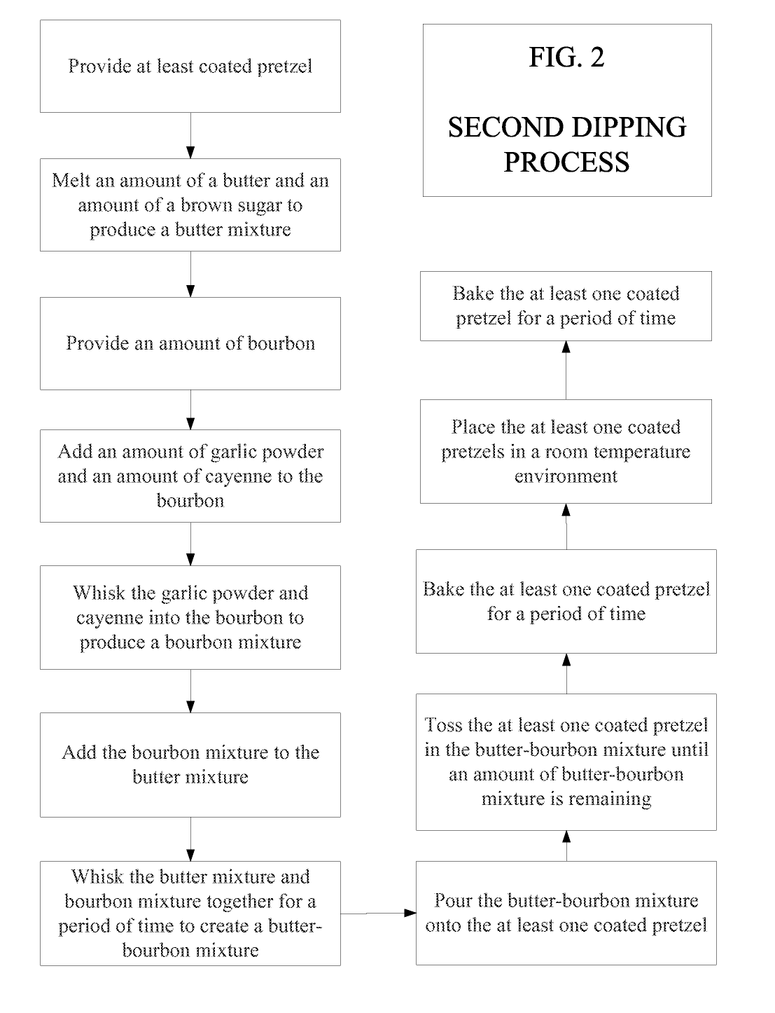

Referring now to FIG. 2, a flow diagram illustrating the steps of a method for a second dipping process in accordance with exemplary embodiments of the present invention is provided. The second dipping process can be performed immediately following the first dipping process, as illustrated in FIG. 1.

In an embodiment of the present invention, method 200 includes providing a coated pretzel (step 201). The coated pretzel can be the pretzel that has finished the first dipping process as described in method 100.

Next, in method 200, an amount of a butter and an amount of a brown sugar are melted to produce a butter mixture (step 202). The butter can be salted or unsalted butter. The butter and brown sugar can be any type, as would be understood by a person of ordinary skill in the art. In an embodiment of the invention, the amount of butter is ½ pound of salted butter. In an embodiment of the invention, the amount of brown sugar is ½ cup of brown sugar. As would be understood by a person of ordinary skill in the art, the butter and brown sugar can be melted in a thick bottom pot. Further, a whisk can be used to dissolve the brown sugar clumps.

Further, in method 200, an amount of bourbon is provided (step 203). As would be understood by a person of ordinary skill in the art, any type of bourbon can be used. In an embodiment of the invention, the amount of bourbon is ⅔ cup of bourbon. In an embodiment of the invention, the bourbon is provided in a liquid measuring cup.

Next, in method 200, an amount of garlic powder and an amount of cayenne are added to the bourbon (step 204). In an embodiment of the invention, the amount of garlic powder is two teaspoons of garlic powder. In an embodiment of the invention, the amount of cayenne is ½ teaspoon. The garlic powder and cayenne can be added to the liquid measuring cup containing the bourbon.

Method 200 also contains the step of whisking the garlic powder and cayenne into the bourbon to produce a bourbon mixture (step 205). In an embodiment of the invention, the garlic powder and cayenne is whisked immediately after adding the ingredients to the bourbon. The garlic powder and cayenne can be whisked until the powders are dissolved and no clumps are observed, as would be understood by a person of ordinary skill in the art.

Next, in method 200, the bourbon mixture is added to the butter mixture (step 206). In an embodiment of the invention, the bourbon mixture is added to the butter mixture in a thick bottom pot. The pot may make a hissing noise once the bourbon mixture is added to the butter mixture.

Further, in method 200, the butter mixture and the bourbon mixture are whisked together for a period of time to create a butter-bourbon mixture (step 207). In an embodiment of the invention, the butter mixture and the bourbon mixture are whisked together for a minute. As would be understood by a person of ordinary skill in the art, the butter mixture and the bourbon mixture can be whisked until it is a golden brown.

Next, in method 200, the butter-bourbon mixture is poured onto the at least one uncoated pretzel (step 208). In an embodiment of the invention, the butter-bourbon mixture is poured evenly onto the pretzels.

Further, in method 200, the at least one pretzel is tossed in the butter-bourbon mixture until an amount of butter-bourbon mixture is remaining to produce at least one coated pretzel (step 209). In an embodiment of the invention, a large spatula is used to toss the pretzels in a butter-bourbon mixture. The butter-bourbon mixture can be tossed until there is no amount of butter-bourbon mixture remaining. Alternatively, the butter-bourbon mixture can be tossed until a portion of the butter-bourbon mixture is remaining. In an embodiment of the present invention, the pretzels are tossed for a few minutes in the butter-bourbon mixture. A clear bowl can be used for tossing the pretzels so that the bowl can easily be observed to determine the amount of liquid butter-bourbon mixture is remaining.

Next, in method 200, the at least one coated pretzel is baked for a period of time (step 210). In an embodiment of the invention, the oven is pre-heated prior to heating the at least one coated pretzel. The pretzels can be placed on baking sheets with parchment paper prior to inserting into the oven. The pretzels may be touching each other on the baking sheet. The pretzels, however, should not be piled high as to prevent the pretzels from baking thoroughly. In an embodiment of the invention, the baking sheets containing the pretzels are placed on the center rack of the oven and away from the bottom of the oven to avoid burning. In an embodiment of the invention, the pretzels are baked in a standard, household oven for 20 minutes at 250 degrees Fahrenheit. In an embodiment of the invention, the pretzels are baked in a convection oven for 15 minutes at 250 degrees Fahrenheit. As would be understood by one of ordinary skill in the art, the time for baking may alter depending on the oven being used.

Further, in method 200, the at least one coated pretzel is placed in a room temperature environment for a period of time (step 211). While in a room temperature environment, the pretzels can be mixed on the baking sheet.

Next, in method 200, the at least one coated pretzel is baked for a second period of time (step 212). In an embodiment of the invention, the pretzels are baked for a second period of time in a standard, household oven for 20 minutes at 250 degrees Fahrenheit. In an embodiment of the invention, the pretzels are baked for a second period of time in a convection oven for 10 minutes at 250 degrees Fahrenheit. Once the at least one coated pretzel is baked, it can be removed from the oven and placed at room temperature for 10-15 minutes.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the methods described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

We claim:

1. A method for making a bourbon soaked pretzel comprising:
melting a first amount of butter and a first amount of brown sugar to produce a butter mixture;
adding a first amount of garlic powder and a first amount of cayenne to a first amount of bourbon to produce a bourbon mixture;
adding the bourbon mixture to the butter mixture;
whisking the butter mixture and the bourbon mixture together to create a butter-bourbon mixture;
pouring the butter-bourbon mixture on at least one uncoated pretzel;
tossing the at least one uncoated pretzel in the butter-bourbon mixture to produce a coated pretzel;
baking the at least one coated pretzel for a first period of time at a first temperature;
placing the at least one coated pretzel in a room temperature environment; and
baking the at least one coated pretzel for a second period of time at a second temperature.

2. The method of claim 1, wherein the first amount of butter is about one pound of salted butter.

3. The method of claim 1, wherein the first amount of brown sugar is about ½ cup of brown sugar.

4. The method of claim 1, wherein the first amount of garlic powder is about three teaspoons of garlic powder.

5. The method of claim 1, wherein the first amount of cayenne is about one teaspoon of cayenne.

6. The method of claim 1, wherein the first amount of bourbon is about ¾ cup of bourbon.

7. The method of claim 1, wherein the butter mixture and the bourbon mixture are whisked together for at least one minute.

8. The method of claim 1, wherein the baking takes place in a convection oven and the first period of time is about 15 minutes, the first temperature is about 250 degrees Fahrenheit, the second period of time is about 10 minutes, and the second temperature is about 250 degrees Fahrenheit.

9. The method of claim 1, wherein the baking takes place in a household oven and the first period of time is about 20 minutes, the first temperature is about 250 degrees Fahrenheit, the second period of time is about 20 minutes and the second temperature is about 250 degrees Fahrenheit.

10. The method of claim 1 further comprising:
melting a second amount of butter and a second amount of brown sugar to produce a butter mixture;
adding a second amount of garlic powder and a second amount of cayenne to a second amount of bourbon to produce a bourbon mixture;
adding the bourbon mixture to the butter mixture;
whisking the butter mixture and the bourbon mixture together to create a butter-bourbon mixture;
pouring the butter-bourbon mixture on the at least one coated pretzel;
tossing the at least one coated pretzel in the butter-bourbon mixture;
baking the at least one coated pretzel for a third period of time at a third temperature;
placing the at least one coated pretzel in a room temperature environment; and
baking the at least one coated pretzel for a fourth period of time at a fourth temperature.

11. The method of claim 10, wherein the second amount of butter is about ½ pound of salted butter.

12. The method of claim 10, wherein the first amount of brown sugar is about ½ cup of brown sugar.

13. The method of claim 10, wherein the first amount of garlic powder is about two teaspoons of garlic powder.

14. The method of claim 10, wherein the first amount of cayenne is about ½ teaspoon of cayenne.

15. The method of claim 10, wherein the first amount of bourbon is about ⅔ cup of bourbon.

16. The method of claim 10, wherein the butter mixture and the bourbon mixture is whisked together for at least one minute.

17. The method of claim 10, wherein the baking takes place in a convection oven and the first period of time is about 15 minutes, the first temperature is about 250 degrees Fahrenheit, the second period of time is about 10 minutes, and the second temperature is about 250 degrees Fahrenheit.

18. The method of claim 10, wherein the baking takes place in a household oven and the first period of time is about 20 minutes, the first temperature is about 250 degrees Fahrenheit, the second period of time is about 20 minutes and the second temperature is about 250 degrees Fahrenheit.

19. A coated pretzel produced by a process comprising:
melting a first amount of butter and a first amount of brown sugar to produce a butter mixture;
adding a first amount of garlic powder and a first amount of cayenne to a first amount of bourbon to produce a bourbon mixture;
adding the bourbon mixture to the butter mixture;
whisking the butter mixture and the bourbon mixture together to create a butter-bourbon mixture;
pouring the butter-bourbon mixture on at least one uncoated pretzel;
tossing the at least one uncoated pretzel in the butter-bourbon mixture to produce a coated pretzel;
baking the at least one coated pretzel for a first period of time at a first temperature;
placing the at least one coated pretzel in a room temperature environment; and
baking the at least one coated pretzel for a second period of time at a second temperature.

20. A coated pretzel produced by a process comprising:
melting a first amount of butter and a first amount of brown sugar to produce a butter mixture;
adding a first amount of garlic powder and a first amount of cayenne to a first amount of bourbon to produce a bourbon mixture;
adding the bourbon mixture to the butter mixture;
whisking the butter mixture and the bourbon mixture together to create a butter-bourbon mixture;
pouring the butter-bourbon mixture on at least one uncoated pretzel;
tossing the at least one uncoated pretzel in the butter-bourbon mixture to produce a coated pretzel;
baking the at least one coated pretzel for a first period of time at a first temperature;
placing the at least one coated pretzel in a room temperature environment;
baking the at least one coated pretzel for a second period of time at a second temperature;
melting a second amount of butter and a second amount of brown sugar to produce a butter mixture;
adding a second amount of garlic powder and a second amount of cayenne to a second amount of bourbon to produce a bourbon mixture;
adding the bourbon mixture to the butter mixture;
whisking the butter mixture and the bourbon mixture together to create a butter-bourbon mixture;
pouring the butter-bourbon mixture on the at least one coated pretzel;
tossing the at least one coated pretzel in the butter-bourbon mixture;
baking the at least one coated pretzel for a third period of time at a third temperature;
placing the at least one coated pretzel in a room temperature environment; and
baking the at least one coated pretzel for a fourth period of time at a fourth temperature.
